(19) United States
(12) Patent Application Publication
(10) Pub. No.: US 2008/0130485 A1
(43) Pub. Date: Jun. 5, 2008

(54) SIGNAL MODULATION METHOD BASED ON ORTHOGONAL FREQUENCY DIVISION MULTIPLEX AND A MODULATION DEVICE THEREOF

(75) Inventor: Xuezhi YANG, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 12/027,775

(22) Filed: Feb. 7, 2008

Related U.S. Application Data
(63) Continuation of application No. PCT/CN2006/001835, filed on Jul. 25, 2006.

(30) Foreign Application Priority Data
Aug. 8, 2005 (CN) 200510089837.9

(51) Int. Cl. H04J 11/00; H04J 1/00

(52) U.S. Cl. 370/208; 370/480

(57) ABSTRACT

The present disclosure discloses a signal modulation method based on orthogonal frequency division multiplex, including: determining a baseband frequency range according to a baseband chip rate; determining N frequency range subsets within the baseband frequency range, wherein N is a natural number; selecting n(1 [symbol] n [symbol] N) frequency range subsets from the N frequency range subsets, wherein 1 [symbol] n [symbol] N; generating a baseband signal whose frequency range is restricted to the n frequency range subsets; and modulating the baseband signal generated onto a carrier. Correspondingly, the present disclosure further provides a signal modulation device based on orthogonal frequency division multiplex. With the present disclosure, a terminal and a base station may implement communication based on different transmission bandwidths even if they only support a set of parameters.

### CROSS-REFERENCE TO RELATED APPLICATIONS

The present application is a continuation of PCT application PCT/CN2006/001835, filed on Jul. 25, 2006, entitled “A SIGNAL MODULATION METHOD BASED ON ORTHOGONAL FREQUENCY DIVISION MULTIPLE AND THE APPARATUS THEREOF”, which claims priority to Chinese Patent Application No. 200510089837.9, filed Aug. 8, 2005, both of which are incorporated by reference herein in its entirety.

### FIELD OF THE INVENTION

The disclosure relates to the technical field of orthogonal frequency division multiplex (OFDM) technology, and in particular to a signal modulation method based on OFDM and a modulation device thereof.

### BACKGROUND OF THE INVENTION

The next generation mobile communication technologies need to support various service types such as voice, data, audio, video and image. In order to support various services, it is required that a next generation mobile communication system can support higher data transmission rate and higher spectrum efficiency, provide a perfect quality of service (QoS) guarantee mechanism as well as provide a better mobility support and seamless coverage of network, so as to achieve the object of providing communication service for users anywhere and at any time. In the 2^{nd} mobile communications, TDMA (GSM) and narrowband CDMA (IS-95) are main access technologies, and in the 3^{rd} mobile communications, broadband CDMA (UMTS, WCDMA) is a main access technology. In the CDMA technology, a user data symbol occupies all the carrier bandwidth, and different users or user data are distinguished from each other via different spreading codes. Because the orthogonality of the spreading codes is destroyed by multi-path channels, the system in the CDMA technology becomes a self-interference system. Therefore, the capacity and spectrum efficiency of the CDMA system cannot satisfy the requirements by the future broadband wireless communications.

Since the 1990's, multi-carrier technology has become a hotspot of the broadband wireless communications. The fundamental idea of this technology is dividing a broadband carrier into a plurality of sub-carriers, and transmitting data on the sub-carriers in parallel. In a majority of system applications, the bandwidth of a sub-carrier is smaller than the coherent bandwidth of the channel, so the fading on each sub-carrier is a flat fading on a frequency selective channel. Therefore, the interference between the user data symbols is reduced, and no complicated channel equalization is required, which is suitable for the high rate data transmission. At present, there exist a plurality of multi-carrier technologies, such as orthogonal frequency division multiplex access (OFDMA) and multiplex carrier CDMA (MC-CDMA).

The orthogonal frequency division multiplex (OFDM) was first put forward in the middle of 1960's. However, in quite a long period of time thereafter, no large scale application with the OFDM technology could be realized. At that time, many problems blocked the development of the OFDM technology.

First, it is required in the OFDM technology that the sub-carriers should be orthogonal to each other. Although it was found theoretically that this orthogonal modulation may be realized perfectly with the Fast Fourier Transformation (FFT), the implementation of the FFT is so complicated that it could not be realized at that time.

Furthermore, factors such as the stability of the oscillators in the transmitter and receiver as well as the linearity of the radio power amplifier were all restrictions on the implementation of the OFDM technology.

Since the 1980's, the problem of implementation of the FFT has been resolved with the development of the large scale integrated circuit. With the development of the DSP chip technology, the OFDM technology has evolved from the theory to the practical application. Due to advantages of the inherent relatively strong resistance to the time delay spread and relatively high spectrum efficiency, the OFDM technology becomes rapidly a focus of the research and is adopted by a plurality of international specifications, such as Digital Audio Broadcasting (DAB) standard, Digital Video Broadcasting (DVB) standard, HIPERLAN and Wireless Local Area Network (WLAN) standard of IEEE 802.11 as well as Wireless Metropolitan Area Network (WMAN) standard of IEEE 802.16.

In the 3GPP RAN meeting #26 held in November, 2004, project Long Term Evolution (LTE) of UMTS is initiated by a plurality of operators and device vendors jointly, and the multi-carrier technology is an access technology mainly involved in the discussion. In the 3GPP LTE, as a mainstream multiple access solution, the downlink OFDMA, uplink DFT-spread-OFDM, SC-FDMA and IFDMA are involved in the discussion.

The OFDMA technology is a representative technology in the multi-carrier technologies. As shown in FIG. 1, user data is first subject to channel encoding and interleaving processing, then modulated with a modulation mode (such as BPSK, QPSK and QAM) to obtain a user data symbol, and modulated to radio frequency through the operation of the OFDM system. In the operation of the OFDM system, the user data symbol is first serial/parallel converted, so as to form a plurality of low-rate sub data streams, each sub data stream occupying a sub-carrier. The mapping from the sub data stream to the sub-carrier may be realized via an Inverse Discrete Fourier Transformation (IDFT) or Inverse Fast Fourier Transformation (IFFT). Meanwhile, a Cyclic Prefix (CP) is used as guard interval between the sub data streams, so that the inter-symbol interference may be greatly reduced or even eliminated. Furthermore, the orthogonality between the channels may be guaranteed, so that the inter-channel interference may be greatly reduced.

However, in the practical application of the OFDMA technology, there exists a problem of high Peak-to-Average Ratio (PAR). The high PAR decreases the efficiency of the power amplifier and the coverage area of the network. Especially for an uplink application, because the transmission power of the terminal is relatively small, the problem of high PAR is particularly disadvantageous for the communication system. Therefore, it is further put forward in the 3GPP LTE that the DFT-S-OFDM technology, which has a relatively low PAR, may be employed as an alternative technology of the multi-carrier solution in uplink. The block diagram of the working principle of the DFT-S-OFDM technology is as shown in FIG. 2.

In the 3GPP LTE, the function of supporting scalable bandwidth is taken as a requirement, i.e., a communication system should support different bandwidth requirements such as 1.25 MHz, 2.5 MHz, 5 MHz, 10 MHz, 15 MHz and 20 MHz. In order to support scalable bandwidth, a parameter set is configured for each supported bandwidth in the 3GPP TR 25.814 specification. The parameter set includes sampling frequency and FFT size, so as to support different transmission bandwidths. The parameter set corresponding to each transmission bandwidth is as shown in Table 1:

TABLE 1

| | Transmission BW | | | | | |
|---|---|---|---|---|---|---|
| | 1.25 MHz | 2.5 MHz | 5 MHz | 10 MHz | 15 MHz | 20 MHz |
| Sub-frame | 0.5 ms | | | | | |
| duration | | | | | | |
| Sub-carrier | 15 kHz | | | | | |
| spacing | | | | | | |
| Chip Rate/ | 1.92 MHz | 3.84 MHz | 7.68 MHz | 15.36 MHz | 23.04 MHz | 30.72 MHz |
| Sampling | (½ × 3.84 MHz) | | (2 × 3.84 MHz) | (4 × 3.84 MHz) | (6 × 3.84 MHz) | (8 × 3.84 MHz) |
| frequency | | | | | | |
| FFT size | 128 | 256 | 512 | 1024 | 1536 | 2048 |
| Number of | 76 | 151 | 301 | 601 | 901 | 1201 |
| effective | | | | | | |
| sub-carriers | | | | | | |

It can be seen that in this table of the parameter set, considering the support of mobility by the OFDM system and the compromise of the coherent bandwidth, 15 kHz is adopted as sub-carrier spacing for different transmission bandwidths. In systems with different transmission bandwidths, the sub-carrier spacing is maintained constant while the corresponding sampling frequency and the FFT size is changed.

However, when the supporting of different transmission bandwidths is realized by maintaining the above parameter set in the OFDM technology, there are following disadvantages:

1. It is desired to adopt 2-based algorithm when implementing FFT computation, because the 2-based FFT involves relatively low operation and can be conveniently implemented. However, it can be seen from above table that with respect to the transmission bandwidth of 15 MHz, the 2-based FFT algorithm could not be employed which increases the computation complexity.

2. If a terminal and a base station only support a sampling frequency and an FFT size in the above table respectively, the communication between the terminal and the base station can be implemented only when the communication is based on the same transmission bandwidth.

3. At present, in order to support the communication between the terminal and the base station based on different transmission bandwidths, it is required that the terminal and the base station are able to support the six sampling frequencies and FFT sizes in the above table respectively, i.e., the terminal and the base station should be able to support a plurality of parameter sets in the above table at the same time. Thus, the cost of the terminal and the base station will definitely be increased.

### SUMMARY OF THE INVENTION

The technical problem to be resolved by the disclosure is to provide a signal modulation method based on OFDM and a modulation device thereof, so that the terminal and the base station can perform communication base on different transmission bandwidths even if the terminal and the base station only support a set of parameters.

To resolve the above problems, the disclosure provides following technical solutions.

A signal modulation method based on orthogonal frequency division multiplex comprises:

determining a baseband frequency range according to a baseband chip rate;

determining N frequency range subsets within the baseband frequency range, wherein N is a natural number;

selecting n frequency range subsets from the N frequency range subsets, wherein 1 [symbol] n [symbol] N; generating a baseband signal whose frequency range is restricted to the n frequency range subsets; and

modulating the baseband signal generated onto a carrier.

Preferably, in the process of determining the baseband frequency range according to the baseband chip rate, a maximum range of the baseband frequency range is determined according to the baseband chip rate.

Preferably, in the process of determining N frequency range subsets within the baseband frequency range, each frequency range subset is non-overlapping.

Preferably, in the process of determining N frequency range subsets within the baseband frequency range, when determining each frequency range subset, it is guaranteed that a specified frequency range interval is reserved between every two neighboring frequency range subsets.

Preferably, the frequency range subset is formed by excluding a guard band from a system carrier bandwidth.

Preferably, in the process of selecting n frequency range subsets from the N frequency range subsets, and generating the baseband signal whose frequency range is restricted to the n frequency range subsets, an Inverse Fast Fourier Transformation is used to generate the baseband signal.

Preferably, in the process of selecting n frequency range subsets from the N frequency range subsets, and generating the baseband signal whose frequency range is restricted to the n frequency range subsets, the baseband signal whose frequency range is restricted to the n frequency range subsets is generated by setting a power of the sub-carrier corresponding to the frequency range outside the n frequency range subsets selected to zero.

Preferably, the process of determining N frequency range subsets within the baseband frequency range further comprises: modifying the frequency range for the frequency range subset determined.

Preferably, if N [symbol] 2, the process of determining N frequency range subsets within the baseband frequency range further comprises:

selecting m frequency range subsets from the N frequency range subsets determined, and

combining the m frequency range subsets selected into a frequency range subset.

Preferably, in the process of selecting m frequency range subsets from the N frequency range subsets determined, the m frequency range subsets selected are continuous.

Preferably, the frequency range of the frequency range subset obtained through combination in the process of combining the m frequency range subsets selected into the frequency range subset comprises:

frequency ranges corresponding to the m frequency range subsets selected respectively; and

frequency range intervals between every two neighboring frequency range subsets in the m continuous frequency range subsets.

Preferably, in the process of determining the baseband frequency range according to the baseband chip rate, the baseband chip rate is 30.72 MHz; and in the process of determining N frequency range subsets within the baseband frequency range, frequency range subsets whose widths are 1.25 MHz, 2.5 MHz, 5 MHz, 10 MHz, 15 MHz, 20 MHz respectively are determined.

Preferably, the method is used in:

an Orthogonal Frequency Division Multiplex Access system;

a Discrete Fourier Transformation Spread Orthogonal Frequency Division Multiplex Access system; or

a Multiplex Carrier Code Division Multiple Access system.

Correspondingly, the present disclosure further provides a signal modulation device based on orthogonal frequency division multiplex, comprising:

a baseband frequency range determining unit, adapted to determine a baseband frequency range according to a baseband chip rate;

a frequency range subset determining unit, adapted to determine N frequency range subsets within the baseband frequency range, wherein N is a natural number;

a baseband signal generating unit, adapted to select n frequency range subsets from the N frequency range subsets, and generate a baseband signal whose frequency range is restricted to the n frequency range subsets, wherein 1 [symbol] n [symbol] N; and

a modulating unit, adapted to modulate the baseband signal generated onto a carrier.

Preferably, the signal modulation device according to claim 14, further comprises:

a selecting unit, adapted to select m frequency range subsets from the N frequency range subsets determined; and

a combining unit, adapted to combine the m frequency range subsets selected into a frequency range subset.

Preferably, the baseband signal generating unit specifically comprises:

a selecting sub-unit, adapted to select n frequency range subsets from the N frequency range subsets;

a zero setting sub-unit, adapted to set a power of a sub-carrier corresponding to a frequency range outside the n frequency range subsets selected to zero; and

a baseband signal generating sub-unit, adapted to generate a baseband signal whose frequency range is restricted to the n frequency range subsets selected.

Preferably, the baseband signal generating unit adopts Inverse Fast Fourier Transformation to generate the baseband signal.

N frequency range subsets are determined with the baseband frequency range determined by the baseband chip rate, n frequency range subsets (1 [symbol] n [symbol] N) are selected from the N frequency range subsets, and a baseband signal whose frequency range is restricted to the n frequency range subsets is generated; and then the baseband signal generated is modulated onto a carrier, so that the following advantages may be obtained:

1) A plurality of transmission bandwidths may be supported with a set of transmission parameters, so that the investment of development of base station and terminal device may be reduced;

2) The non 2-based FFT operation between the existing different transmission bandwidths may be avoided, so that the complexity of implementing different transmission bandwidths may be reduced;

3) The inter-working at the physical layer between the transmitter and receiver based on different transmission bandwidths may be realized, and the forward and backward compatibility of the physical layer of the wireless communication system may be further realized, so that a smooth and seamless evolution of the wireless communication system may be practically realized.

### BRIEF DESCRIPTION OF THE DRAWINGS

FIG. 1 is a block diagram showing the working principle of OFDM in the prior art;

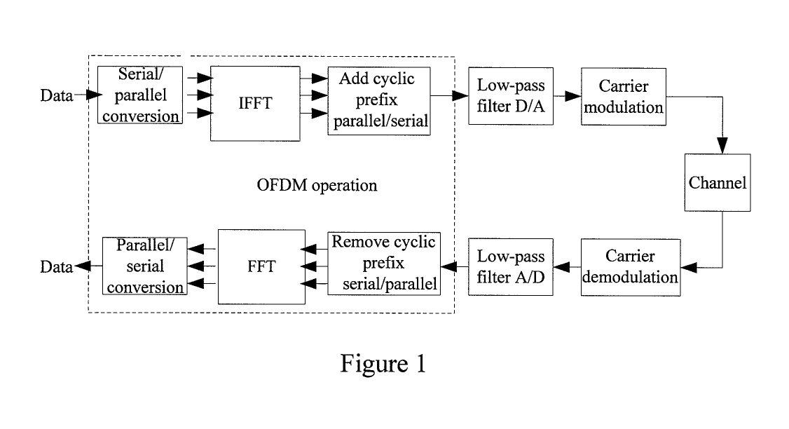

FIG. 2 is a block diagram showing the working principle of the DFT-S-OFDM in the prior art;

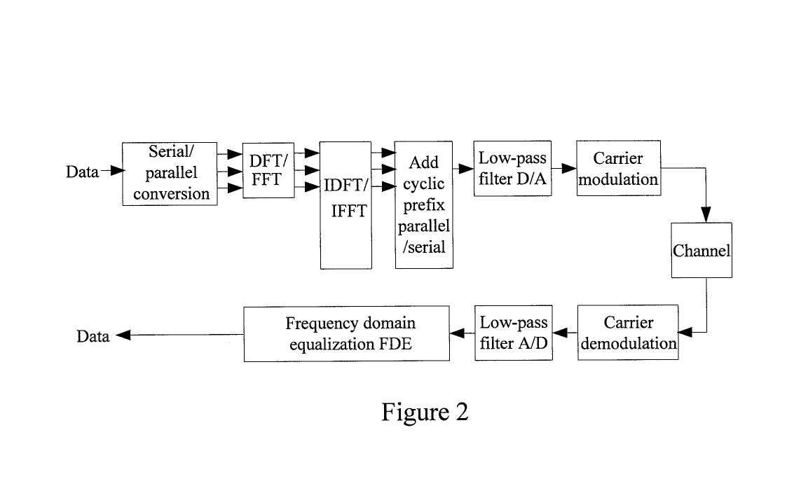

FIG. 3 is a flow chart of the main implementing principle of a signal modulation method based on OFDM according to the disclosure;

FIG. 4 is a schematic diagram showing an embodiment of supporting two transmission bandwidths with a set of parameters based on the method provided by the disclosure;

FIG. 5 is a schematic diagram showing the main structure of a signal modulation device based on OFDM according to the disclosure;

FIG. 6 is a schematic diagram showing the structure of the signal modulation device with an additional frequency range subset combination function according to an embodiment of the disclosure; and

FIG. 7 is a schematic diagram showing the specific structure of a baseband signal generating unit in the device provided by the disclosure.

### DETAILED DESCRIPTION OF THE EMBODIMENTS

With respect to the defect that only one transmission bandwidth can be supported with a set of parameters (including a sampling frequency and an FFT size) in the existing OFDM technology, the present disclosure provides a technical solution in which an scalable bandwidth may be realized in the wireless communication system, so that a communication may be implemented based on different transmission bandwidths even if a terminal and a network only supports a set of parameters respectively. Meanwhile, forward compatibility and backward compatibility may be realized in the multiple access technology of the wireless communication system.

Hereinafter, the implementing principle and specific embodiments of a signal modulation method based on OFDM and a modulation device thereof according to the disclosure will be described in detail in conjunction with the drawings.

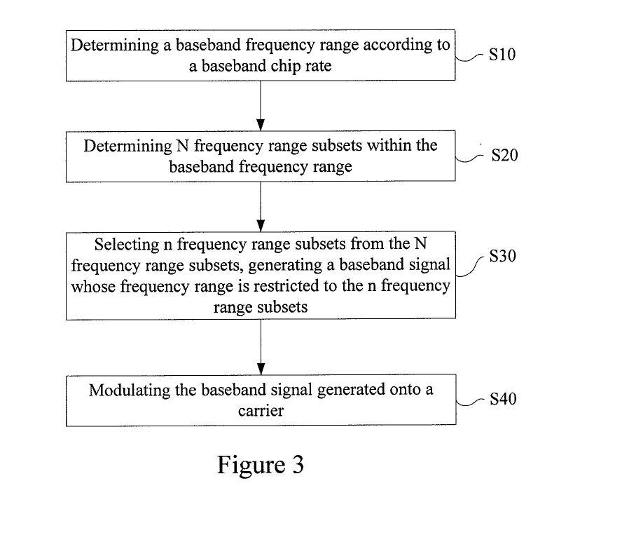

Please refer to FIG. 3, which is a flow chart of the main implementing principle of a signal modulation method based on OFDM according to the disclosure. The main implementing process is as follows:

S10, a chip rate f_{chip} of a baseband signal is selected firstly, a corresponding baseband frequency range is determined according to the baseband chip rate f_{chip} selected. Preferably, a corresponding maximum range [−f_{chip}/2, f_{chip}/2] of the baseband frequency is determined according to the baseband chip rate f_{chip} selected.

S20, N frequency range subsets are determined in the baseband frequency range that is determined above, where N is a natural number. Each frequency range subset determined corresponds to an equivalent carrier frequency and a transmission bandwidth. It can be hypothesized here that the frequency range of each frequency range subset is [f₋, f₊].

According to specific requirements, the frequency range of each frequency range subset determined here may be modified subsequently. In other words, the frequency range of each frequency range subset [f₋, f₊] may be modified to achieve the object of modifying the transmission bandwidth corresponding to each frequency range subset.

Preferably, during the process of determining the frequency range subset, it should be ensured that the frequency range of each frequency range subset determined is non-overlapping. Meanwhile, it should be ensured that a specified frequency range interval is reserved between every two neighboring frequency range subsets, which acts as a guard interval between the two neighboring frequency range subsets.

Meanwhile, m frequency range subsets (2 [symbol] m [symbol] N) may be selected from the N frequency range subsets (N>1) that are determined, and the m frequency range subsets selected may be combined to a new frequency range subset. Preferably, the m frequency range subsets selected are continuous, so that the frequency range of the new frequency range subset obtained through combination may include the frequency ranges corresponding to the m frequency range subsets selected respectively as well as the frequency range intervals between every two neighboring frequency range subsets in the m continuous frequency range subsets.

S30, n frequency range subsets are selected from the N frequency range subsets determined above, where 1 [symbol] n [symbol] N, and a baseband signal whose frequency range is restricted to the n frequency range subsets selected is generated. The process of restricting the frequency range of the baseband signal generated to the n frequency range subsets selected may be as follows:

The transmission power of an OFDM sub-carrier corresponding to a frequency range outside the n frequency range subsets selected is set to zero with an OFDM/IFFT operation. In other words, the numerical vale corresponding to the frequency range outside the n frequency range subsets selected is set to zero in an input sequence of IFFT.

S40, the baseband signal generated above is modulated onto a carrier. If the carrier frequency is f_{c}, the equivalent central carrier frequency corresponding to each frequency range subset that is modulated onto the carrier is f_{c}+(f₊+f₋)/2. It can be seen that the equivalent central carrier frequency may be modified by changing the central position of the frequency range subset of the baseband signal.

In the above S10, a baseband chip rate of 7.68 MHz may be selected. In S20, three frequency range subsets whose widths are 1.25 MHz, 2.5 MHz and 5 MHz respectively may be obtained from the maximum range of the baseband frequency determined by the baseband chip rate of 7.68 MHz, so that based on the chip rate of 7.68 MHz, three different transmission bandwidths, i.e. 1.25 MHz, 2.5 MHz and 5 MHz, may be supported. Furthermore, a baseband chip rate of 30.72 MHz may be selected. In S20, three frequency range subsets whose widths are 10 MHz, 15 MHz and 20 MHz respectively may be obtained from the maximum range of the baseband frequency determined by the baseband chip rate of 30.72 MHz, so that based on the chip rate of 30.72 MHz, three different transmission bandwidths, i.e. 10 MHz, 15 MHz and 20 MHz, may be supported.

In a TDMA system or CDMA system, the transmission bandwidth of the baseband signal is invariable, because the transmission bandwidth of the baseband signal is determined by the chip rate. However, in an OFDM system, the actual transmission bandwidth of the baseband signal may be controlled via sub-carrier in the same chip rate/sampling frequency.

For example, for an OFDM system whose chip rate is f_{chip}, the maximum range of the baseband frequency is [−f_{chip}/2, f_{chip}/2].

If the maximum range of the baseband frequency is modulated to the radio frequency via a frequency whose carrier central frequency is f_{c}, the corresponding radio frequency transmission bandwidth is [f_{c}−f_{chip}/2, f_{c}+f_{chip}/2].

Therefore, when it is required, some sub-carriers of the baseband signal may be set to zero, and the frequency range of the actual baseband signal is restricted to [f₋, f₊]⊂[−f_{chip}/2, f_{chip}/2], which may not be central symmetrical relative to DC. After that, the frequency range of the baseband signal [f₋, f₊] is modulated onto the carrier frequency f_{c}, so the radio frequency transmission bandwidth is [f_{c}+f₋, f_{c}+f₊]=[f_{c}+(f₊+f₋)/2−(f₊−f₋)/2, f_{c}+(f₊+f₋)/2+(f₊−f₋)/2]. In other words, it is equivalent that the transmission bandwidth of the baseband signal is [−(f₊−f₋)/2, (f₊−f₋)/2], and the carrier central frequency becomes f_{c}+(f₊+f₋)/2. Thus, the object of changing the transmission bandwidth and the carrier central frequency by controlling the frequency range at the baseband signal is achieved.

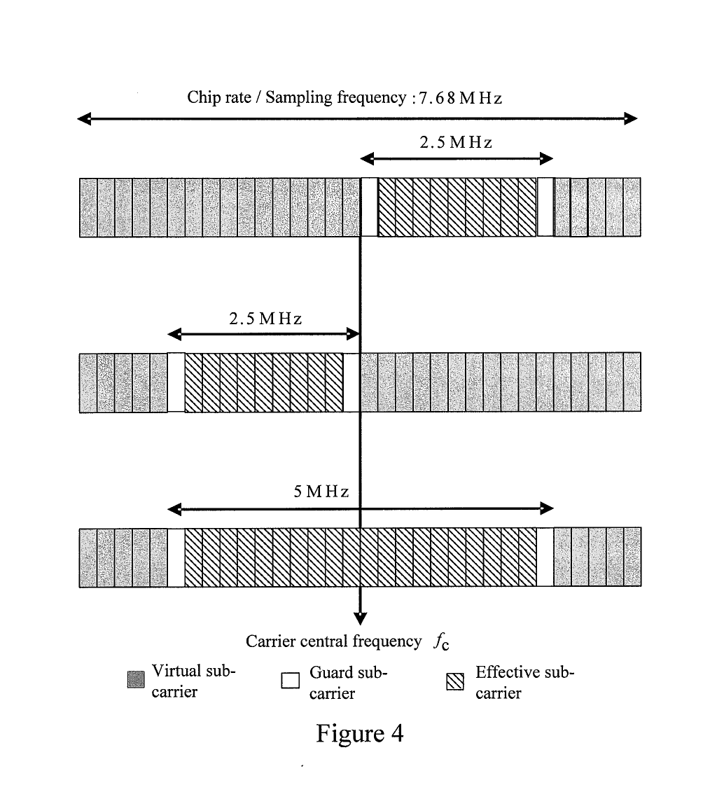

FIG. 4 is a schematic diagram showing an embodiment of supporting two transmission bandwidths with a set of parameters based on the method provided by the disclosure. In FIG. 4, the principle of supporting two different transmission bandwidths with a set of parameters (the chip rate/sampling frequency are both 7.68 MHz) is illustrated. Furthermore, three or more than three different transmission bandwidths may be supported with a set of parameters by analogy. As shown in FIG. 4, three sub-carriers are defined here according to the disclosure:

1. Virtual sub-carrier, refers to the sub-carrier outside the specified transmission bandwidth. Because the chip rate may be higher than the transmission bandwidth, the frequency of some sub-carriers may be outside the transmission bandwidth. These sub-carriers may become the virtual sub-carrier defined here by setting the transmission power of these sub-carriers to zero.

2. Guard sub-carrier, refers to the sub-carrier within the specified transmission bandwidth. The transmission power of these sub-carriers is set to zero to act as guard band, so that the spectrum emission mask may be satisfied. The width of the guard sub-carrier may be flexibly configured according to the requirements on the performance of the filter, so that the transmission bandwidth may be utilized to the maximum extent while satisfying the requirements of the spectrum emission mask.

3. Effective sub-carrier, refers to the sub-carrier that actually carries a signaling or data.

It can be seen that with a chip rate/sampling frequency of 7.68 MHz, a transmission bandwidth of 5 MHz may be supported, or two transmission bandwidths of 2.5 MHz may be supported, through the configuration of the virtual sub-carrier and the guard sub-carrier shown in FIG. 4. Accordingly, four transmission bandwidths of 1.25 MHz or three transmission bandwidths of 1.6 MHz may be supported by analogy.

Based on the above principle, the parameter set corresponding to different transmission bandwidths in the 3GPP LTE system may be modified as shown in the following Table 2:

TABLE 2

| | Transmission BW | | | | | |
|---|---|---|---|---|---|---|
| | 1.25 MHz | 2.5 MHz | 5 MHz | 10 MHz | 15 MHz | 20 MHz |
| Sub-frame duration | 0.5 ms | | | | | |
| Sub-carrier spacing | 15 kHz | | | | | |
| Chip Rate/ | 7.68 MHz | | | 30.72 MHz | | |
| Sampling frequency | (2 × 3.84 MHz) | | | (8 × 3.84 MHz) | | |
| FFT size | 512 | | | 2048 | | |
| Number of sub-carriers | 83 | 166 | 333 | 666 | 1000 | 1333 |
| within BW | | | | | | |
| Number of Guard | 7 | 15 | 32 | 65 | 99 | 132 |
| sub-carriers | | | | | | |
| Number of effective | 76 | 151 | 301 | 601 | 901 | 1201 |
| sub-carriers | | | | | | |

It can be seen from the above Table 2 that the highest chip rate/sampling frequency and longest FFT size may be used for supporting the six transmission bandwidths between 1.25 MHz and 20 MHz. Considering the development stage of the devices, two parameter sets (without limitation) may be selected corresponding to different transmission bandwidths, i.e., chip rate of 7.68 MHz/FFT size of 512 is used for supporting transmission bandwidths of 1.25 MHz, 2.5 MHz and 5 MHz, and chip rate of 30.72 MHz/FFT size of 2048 is used for supporting transmission bandwidths of 10 MHz, 15 MHz and 20 MHz.

The method according to the disclosure may be used in but not limited to the following wireless communication systems:

Orthogonal Frequency Division Multiplex Access (OFDMA) system, Discrete Fourier Transformation Spread Orthogonal Frequency Division Multiplex Access (DFT-S-OFDMA) system, or Multiple Carrier CDMA (MC-CDMA) system.

The requirements on the protocol design of a wireless communication system should satisfy two design constraints. One is that the design should satisfy the requirements raised during the development of society, and the other is that the design is restricted by the state of the art. With the development of the communication technology, the communication system is required to have higher data transmission rate, higher mobility and broader signal coverage area. On the other hand, due to the constraints of the state of the art and investment cost, it is not possible that the technical criteria of a wireless communication system exceed the state of the art greatly. Instead, it is only possible to establish a corresponding communication protocol according to the technical criteria achievable at that time. Going through the development of the 1^{st} Generation, 2^{nd} Generation and 3^{rd} Generation, the mobile communication technology evolves now to a very high level. The communication network becomes increasingly large, and an operator generally invests tens of billion dollars in a communication network. Meanwhile, there exist generally an even larger number of user terminals. Therefore, during the upgrade from an existing wireless network to a new wireless network, if the backward compatibility can be realized, i.e., the new network system is able to support the original terminal devices, the enormous investment of the operator in the existing wireless network system may be protected. Meanwhile, if the forward compatibility can be realized, i.e., the old network system is able to support the new terminal devices, a smooth and seamless upgrade of the existing network system may be achieved, and the operator may start operation without the necessity of completely building a huge new network system of full coverage. Thus, the investment risk of the operator is effectively reduced.

The backward compatibility and forward compatibility of the physical layer of the wireless communication system may both be realized in the solution provided by the disclosure. Hereinafter, it will be illustrated how the bidirectional compatibility is realized in the solution provided by the disclosure.

In order to illustrate that the bidirectional compatibility of the physical layer of the wireless communication system may be realized when adopting the solution provided by the disclosure, it is hypothesized that the basic parameter set for transmission of the original wireless communication system is as shown in the following table:

TABLE 3

| Transmission BW | 2.5 MHz |
|---|---|
| Sub-frame duration | 0.5 ms |
| Sub-carrier spacing | 15 kHz |
| Chip Rate/Sampling frequency | 7.68 MHz (2 × 3.84 MHz) |
| FFT size | 512 |
| Number of sub-carriers within BW | 166 |
| Number of Guard sub-carriers | 15 |
| Number of effective sub-carriers | 151 |

Based on Table 3, in the following Scene I:

The new wireless communication system is upgraded to have a transmission bandwidth of 5 MHz, so a higher peak rate may be supported. Then the parameter set for transmission of the new wireless communication system is as shown in Table 4:

TABLE 4

| | | |
|---|---|---|
| Transmission BW | 2.5 MHz | 5 MHz |

| | |
|---|---|
| Sub-frame duration | 0.5 ms |
| Sub-carrier spacing | 15 kHz |
| Chip Rate/Sampling frequency | 7.68 MHz |
| | (2 × 3.84 MHz) |
| FFT size | 512 |

| | | |
|---|---|---|
| Number of sub-carriers within BW | 166 | 333 |
| Number of Guard sub-carriers | 15 | 32 |
| Number of effective sub-carriers | 151 | 301 |

It can be seen in Scene I that with the solution provided by the disclosure, the baseband signal of the wireless communication network and terminal device whose original transmission bandwidth is 2.5 MHz has the capability of supporting the transmission bandwidth of 5 MHz (because the chip rate/sampling frequency is 7.68 MHz, and FFT size is 512). Therefore, when the existing wireless communication network is upgraded, it is not necessary to made any hardware modification and parameter modification from the baseband to the radio frequency of the original wireless communication network and terminal devices, and even not necessary to modify the software. It is only required to make a certain parameter modification on the resource allocation of the network, so as to realize the forward compatibility and backward compatibility.

Based on Table 3, in the following Scene II:

If the existing wireless communication network with the transmission bandwidth of 5 MHz is further upgraded to the network with the transmission bandwidth of 10 MHz, because the transmission bandwidth of 10 MHz cannot be supported with the original chip rate/sampling frequency of 7.68 MHz and FFT size of 512 in the solution provided by the disclosure, the transmission parameters of the upgraded wireless communication network should be modified to have a chip rate or sampling frequency of 30.72 MHz/FFT size of 2048. The modified parameter set for transmission is as shown in the following Table 5:

TABLE 5

| Transmission BW | 5 MHz | 10 MHz |
|---|---|---|
| Sub-frame duration | 0.5 ms | |
| Sub-carrier spacing | 15 kHz | |
| Chip Rate/Smpling frequency | 7.68 MHz | 30.72 MHz |
| | (2 × 3.84 MHz) | (8 × 3.84 MHz) |
| FFT size | 512 | 2048 |
| Number of sub-carriers within BW | 333 | 666 |
| Number of Guard sub-carriers | 32 | 65 |
| Number of effective sub-carriers | 301 | 601 |

Based on the above, the principle of supporting the backward compatibility, i.e. the new network system supports the old terminal devices, will be firstly illustrated hereinafter.

A1, Transmission performed by base station and reception performed by terminal: The resource allocation at the base station side is performed within the original transmission bandwidth of 5 MHz of the network system, and the new chip rate and FFT size are adopted. The baseband signal is the same as the analog signal of the original network system after D/A conversion. Therefore, the terminal can perform normal reception without the necessity of making any modification.

A2, Transmission performed by terminal and reception performed by base station: The chip rate of 7.68 MHz and FFT size of 512 are adopted in the baseband transmission parameter of the terminal, and the chip rate of 30.72 MHz and FFT size of 2048 are adopted in the baseband transmission parameter when the base station performs reception. Because the transmission signal of the original terminal is a part of the new network system, the base station can receive the transmission signal of the original terminal correctly.

Furthermore, the principle of supporting the forward compatibility, i.e. the old network system supports the new terminal devices, will be illustrated hereinafter.

B1: Transmission performed by base station and reception performed by terminal: The chip rate of 7.68 MHz and FFT size of 512 are adopted in the baseband transmission parameter of the base station, and the chip rate of 30.72 MHz and FFT size of 2048 are adopted in the baseband transmission parameter when the terminal performs reception. Because the transmission signal of the original base station is a part of the capability of the new terminal, the terminal can receive the transmission signal of the original base station correctly.

B2: Transmission performed by terminal and reception performed by base station: The bandwidth resources allocated to the terminal by the system is restricted to 5 MHz of the original network system, and only a subset of the capability of the new terminal is used. In other words, when the terminal adopts the new chip rate and FFT size for baseband signal processing, the baseband signal is the same as the analog signal of the original communication system after D/A conversion. Therefore, the base station can perform reception correctly without the necessity of making any modification.

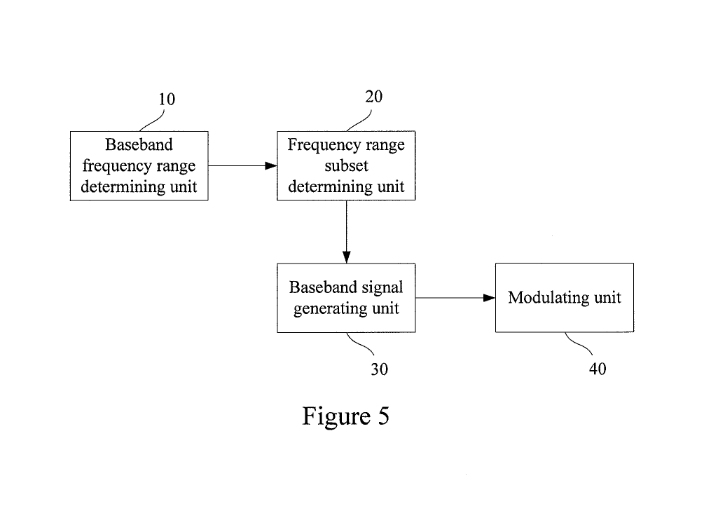

Correspondingly, the disclosure further provides a signal modulation device based on OFDM. Please refer to FIG. 5, which is a schematic diagram showing the main structure of the signal modulation device based on OFDM according to the disclosure. The signal modulation device mainly includes a baseband frequency range determining unit 10, a frequency range subset determining unit 20, a baseband signal generating unit 30 and a modulating unit 40. The function of each part and the connection between them are as follows:

The baseband frequency range determining unit 10 is adapted to determine the baseband frequency range according to the baseband chip rate;

The frequency range subset determining unit 20 is logically connected with the baseband frequency range determining unit 10, and is adapted to determine N frequency range subsets within the baseband frequency range determined by the baseband frequency range determining unit 10, where N is a natural number;

The baseband signal generating unit 30 is logically connected with the frequency range subset determining unit 20, and is adapted to select n frequency range subsets from the N frequency range subsets determined by the frequency range subset determining unit 20 and generate a baseband signal whose frequency range is restricted to the n frequency range subsets, where 1 [symbol] n [symbol] N;

The modulating unit 40 is logically connected with the baseband signal generating unit 30, and is adapted to modulate the baseband signal generated by the baseband signal generating unit 30 onto a carrier.

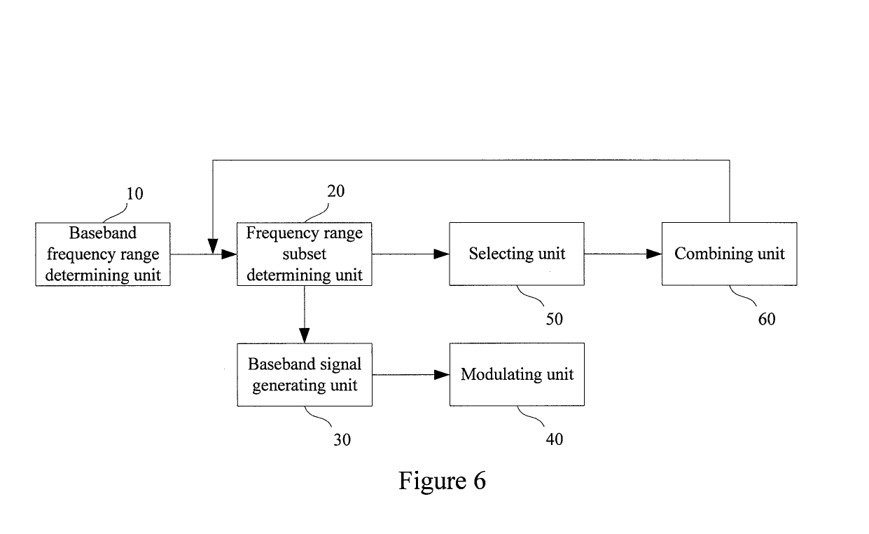

Please refer to FIG. 6, which is a schematic diagram showing the structure of a signal modulation device with an additional frequency range subset combination function according to an embodiment of the disclosure. Based on the structure shown in FIG. 5, the device further includes a selecting unit 50 and a combining unit 60. The specific functions of these two units are as follows:

The selecting unit 50 is logically connected with the frequency range subset determining unit 20, and is adapted to select m frequency range subsets from the N frequency range subsets determined by the frequency range subset determining unit 20, where 2 [symbol] m [symbol] N;

The combining unit 60 is logically connected with the selecting unit 50, and is adapted to combine the m frequency range subsets selected by the selecting unit 50 into a new frequency range subset.

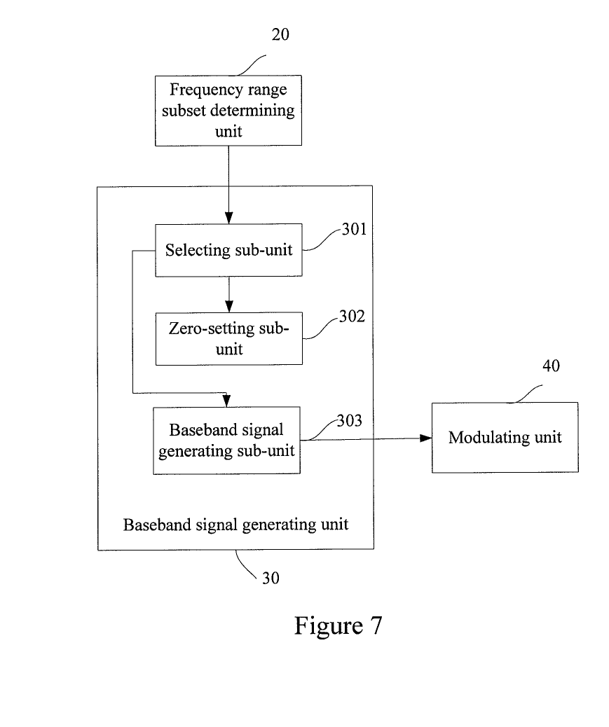

Please refer to FIG. 7, which is a schematic diagram showing the specific structure of a baseband signal generating unit in the device provided by the disclosure. The baseband signal generating unit 30 mainly includes a selecting sub-unit 301, a zero setting sub-unit 302 and a baseband signal generating sub-unit 303. The function of each sub-unit and the connection relation between them is as follows:

The selecting sub-unit 301 is logically connected with the frequency range subset determining unit 20, and is adapted to select n frequency range subsets from the N frequency range subsets determined by the frequency range subset determining unit 20;

The zero setting sub-unit 302 is logically connected with the selecting sub-unit 301, and is adapted to set the transmission power of the sub-carriers corresponding to the frequency range outside the n frequency range subsets selected by the selecting sub-unit 301 to zero;

The baseband signal generating sub-unit 303 is logically connected with the selecting sub-unit 301, and is adapted to generate a baseband signal whose frequency range is restricted to the n frequency range subsets selected by the selecting sub-unit 301.

The baseband signal generating unit 30 may use (without limitation) Inverse Fast Fourier Transformation (IFFT) to generate the baseband signal.

The specific implementing principle of each component of the device provided by the disclosure is already described in the above detailed illustration of the principle of the method. Therefore, it will not be described again here.

Additional advantages and modifications will readily occur to those skilled in the art. Therefore, the invention in its broader aspects is not limited to the specific details and representative embodiments shown and described herein. Accordingly, various modifications and variations may be made without departing from the spirit or scope of the invention as defined by the appended claims and their equivalents.

What is claimed is:

1. A signal modulation method based on orthogonal frequency division multiplex, comprising:
determining a baseband frequency range according to a baseband chip rate;
determining N frequency range subsets within the baseband frequency range, wherein N is a natural number;
selecting n frequency range subsets from the N frequency range subsets, wherein 1 [symbol] n [symbol] N; generating a baseband signal whose frequency range is restricted to the n frequency range subsets;
modulating the baseband signal generated onto a carrier.

2. The method according to claim 1, wherein in the process of determining the baseband frequency range according to the baseband chip rate, a maximum range of the baseband frequency range is determined according to the baseband chip rate.

3. The method according to claim 1, wherein, in the process of determining N frequency range subsets within the baseband frequency range, each frequency range subset is non-overlapping.

4. The method according to claim 1, wherein in the process of determining N frequency range subsets within the baseband frequency range, when determining each frequency range subset, it is guaranteed that a specified frequency range interval is reserved between every two neighboring frequency range subsets.

5. The method according to claim 1, wherein the frequency range subset is formed by excluding a guard band from a system carrier bandwidth.

6. The method according to claim 1, wherein in the process of selecting n frequency range subsets from the N frequency range subsets, and generating the baseband signal whose frequency range is restricted to the n frequency range subsets, an Inverse Fast Fourier Transformation is used to generate the baseband signal.

7. The method according to claim 1, wherein in the process of selecting n frequency range subsets from the N frequency range subsets, and generating the baseband signal whose frequency range is restricted to the n frequency range subsets, the baseband signal whose frequency range is restricted to the n frequency range subsets is generated by setting a power of a sub-carrier corresponding to a frequency range outside the n frequency range subsets selected to zero.

8. The method according claim 1, wherein the process of determining N frequency range subsets within the baseband frequency range further comprises: modifying the frequency range for the frequency range subset determined.

9. The method according to claim 1, wherein if N [symbol] 2, the process of determining N frequency range subsets within the baseband frequency range further comprises:
selecting m frequency range subsets from the N frequency range subsets determined, and
combining the m frequency range subsets selected into a frequency range subset.

10. The method according to claim 9, wherein in the process of selecting m frequency range subsets from the N frequency range subsets determined, the m frequency range subsets selected are continuous.

11. The method according to claim 10, wherein the frequency range of the frequency range subset obtained through combination in the process of combining the m frequency range subsets selected into the frequency range subset comprises:
frequency ranges corresponding to the m frequency range subsets selected respectively; and
frequency range intervals between every two neighboring frequency range subsets in the m continuous frequency range subsets.

12. The method according to claim 1, wherein in the process of determining the baseband frequency range according to the baseband chip rate, the baseband chip rate is 30.72 MHz; and in the process of determining N frequency range subsets within the baseband frequency range, frequency range subsets whose widths are 1.25 MHz, 2.5 MHz, 5 MHz, 10 MHz, 15 MHz, 20 MHz respectively are determined.

13. The method according to 1, wherein the method is used in:
an Orthogonal Frequency Division Multiplex Access system;
a Discrete Fourier Transformation Spread Orthogonal Frequency Division Multiplex Access system; or
a Multiplex Carrier Code Division Multiple Access system.

14. A signal modulation device based on orthogonal frequency division multiplex, comprising:
a baseband frequency range determining unit, adapted to determine a baseband frequency range according to a baseband chip rate;
a frequency range subset determining unit, adapted to determine N frequency range subsets within the baseband frequency range, wherein N is a natural number;
a baseband signal generating unit, adapted to select n frequency range subsets from the N frequency range subsets, and generate a baseband signal whose frequency range is restricted to the n frequency range subsets, wherein 1 [symbol] n [symbol] N; and
a modulating unit, adapted to modulate the baseband signal generated onto a carrier.

15. The signal modulation device according to claim 14, further comprises:
a selecting unit, adapted to select m frequency range subsets from the N frequency range subsets determined; and
a combining unit, adapted to combine the m frequency range subsets selected into a frequency range subset.

16. The signal modulation device according to claim 14, wherein the baseband signal generating unit specifically comprises:
a selecting sub-unit, adapted to select n frequency range subsets from the N frequency range subsets;
a zero setting sub-unit, adapted to set a power of a sub-carrier corresponding to a frequency range outside the n frequency range subsets selected to zero; and
a baseband signal generating sub-unit, adapted to generate a baseband signal whose frequency range is restricted to the n frequency range subsets selected.

17. The signal modulation device according to claim 14, wherein the baseband signal generating unit adopts Inverse Fast Fourier Transformation to generate the baseband signal.
